(19) United States
(12) Patent Application Publication
(10) Pub. No.: US 2010/0214318 A1
(43) Pub. Date: Aug. 26, 2010

(54) NEUROLOGICALLY INFORMED MORPHING

(75) Inventors: Anantha Pradeep, Berkeley, CA (US); Robert T. Knight, Berkeley, CA (US); Ramachandran Gurumoorthy, Berkeley, CA (US)

Correspondence Address: Weaver Austin Villeneuve & Sampson LLP, P.O. BOX 70250, OAKLAND, CA, 94612-0250, US

(73) Assignee: NeuroFocus, Inc., Berkeley, CA (US)

(21) Appl. No.: 12/391,915

(22) Filed: Feb. 24, 2009

(51) Int. Cl. G09G 5/00

(52) U.S. Cl. 345/646

(57) ABSTRACT

Morphing of source and target media including images, video, and audio is performed in a neurologically informed manner. Neurological data is used to determine optimal or near optimal source media and target media contribution levels for morphs that can be used to influence bias, persuasion, etc. Categorical perception shift boundaries and other regions are analyzed in evaluating contribution levels. Neurologically salient attributes of media are determined and morphed more significantly than less neurologically salient attributes.

### TECHNICAL FIELD

The present disclosure relates to morphing. More particularly, the present disclosure relates to analysis of morphing and performing neurologically informed morphing.

### DESCRIPTION OF RELATED ART

A variety of conventional systems are available for morphing media. Media may include images, video, and audio. In some examples, two facial images are morphed to determine a mid-point between the two facial images. The two images would be marked with points and vectors indicating locations of various features. The two images would then be faded into each other as points and vectors are combined. Morphing has been widely used for entertainment purposes.

Although a variety of morphing mechanisms are available, the ability to analyze and perform neurologically informed morphing is limited. Consequently, it is desirable to provide improved mechanisms for analyzing and performing neurologically informed morphing.

### BRIEF DESCRIPTION OF THE DRAWINGS

The disclosure may best be understood by reference to the following description taken in conjunction with the accompanying drawings, which illustrate particular example embodiments.

FIG. 1 illustrates one example of a system for performing neurologically informed morphing.

FIG. 2 illustrates one example of video and image morphing.

FIG. 3 illustrates one example of audio morphing.

FIG. 4 illustrates one example of a graphic depicting categorical perception change.

FIG. 5 illustrates one example of a system for analyzing a categorical perception shift boundary and implementing neurologically informed morphing.

FIG. 6 illustrates one example of a technique for analyzing categorical perception change.

FIG. 7 illustrates one example of a technique for performing neurologically informed morphing.

FIG. 8 provides one example of a system that can be used to implement one or more mechanisms.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques and mechanisms of the present invention will be described in the context of particular types of media. However, it should be noted that the techniques and mechanisms of the present invention apply to a variety of different types of media. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Morphing of source and target media including images, video, and audio is performed in a neurologically informed manner. Neurological data is used to determine optimal or near optimal source media and target media contribution levels for morphs that can be used to influence bias, persuasion, etc. Categorical perception shift boundaries and other regions are analyzed in evaluating contribution levels. Neurologically salient attributes of media are determined and morphed more significantly than less neurologically salient attributes.

### Example Embodiments

Morphing refers to the gradual transformation of source media, such as an image, video, or audio clip, to target media. Morphing techniques are well known and widely used in entertainment. Morphing can be implemented using a combination of mechanisms including warping, color interpolation, fading, blending, dissolving, etc. In one example, two images are warped to have the same general shape and then cross-dissolved into each other. The midpoint between the source media and the target media represents the morphed media having a 50% source media contribution and a 50% target media contribution.

In particular instances, media associated with different categories can be morphed. For example, an image of a dog can be morphed into an image of a cat. In another example, a video showing a Democratic politician giving a speech can be morphed into a video showing a Republican politician giving a speech. In still other examples, a male voice may be morphed into a female voice. In still other examples, a video of an actor in a video is morphed into the video of an actor in another video.

The techniques of the present invention recognize that human perception of categorical perception shifts occurs quickly and dramatically. In one example where an image changes from 100% cat to 100% dog in 10% increments, e.g. 90% cat and 10% dog, 80% cat and 20% dog, 70% cat and 30% dog, etc, humans perceive a cat until the image is approximately 60% cat and 40% dog. Humans begin perceiving dog when the image is 40% cat and 60% dog. The categorical perception change that occurs typically near the midpoint a morph is significant and neurologically dramatic.

The techniques and mechanisms of the present invention recognize that activity in particular portions of the brain involving the lateral frontal cortex increases significantly at the categorical perception shift boundary. In some examples, frontal cortex and connected region activity in distributed neural networks increases at the categorical perception shift boundary. In particular embodiments, activity associated with the lateral frontal cortex or frontal cortex is measured. Activity may include activity within the lateral frontal cortex itself or activity between connected regions and associated neural networks. Consequently, mechanisms are provided to analyze categorical perception shift boundaries by measuring neurological and neuro-physiological activity associated with various brain regions such as the frontal cortex and connected areas using mechanisms such as Electroencephalography (EEG) and functional Magnetic Resonance Imaging (fMRI). According to various embodiments, the techniques and mechanisms of the present invention use morphs in the pre-categorical perception shift region.

Categorical perception shift boundaries vary with the type of morphing performed as well as the type of content depicted, so analysis can be performed for particular media such as individual images or may be performed for various categories of objects and entities as well as various morphing mechanisms. In some embodiments, neuroanalysis is performed to determine categorical perception shift boundaries.

The techniques and mechanisms of the present invention recognize that even before a categorical perception shift, subjects undergo implicit behavioral changes. For example, a subject that dislikes cats but loves dogs may begin to have an affinity for an image that the subject still categorizes as cat, but is 75% cat and 25% dog. The implicit behavioral changes occur even though a subject does not recognize that the image was altered.

According to various embodiments, neurologically salient attributes of media are determined and morphed more significantly than less neurologically salient attributes. In some examples, eyes, nose, and mouth are morphed more significantly than hair or face shape. For example, a cat image may have cat eyes with a 30% dog contribution while the rest of the cat image only has a 10% dog contribution.

Neurological data is used to determine optimal or near optimal pre-categorical perception shift boundary morphing levels that can be used to influence bias and persuasion. It should be noted that other characteristics such as engagement and retention levels can also be influenced. In one example, an image representing a corporation may be morphed into images that match particular preferences of a local population. A company with an animal mascot can use neurological data to determine preferred animals in a foreign country and modify their mascot by morphing their animal mascot with another animal in a foreign market. Weighted morphing of neurologically salient features can be used to alter a mascot with subtlety, while still influencing bias and perception of the mascot and the company. Influencing bias may involve changing the likelihood that a subject will purchase a particular product, vote for a particular candidate, like a particular person, or choose a particular service.

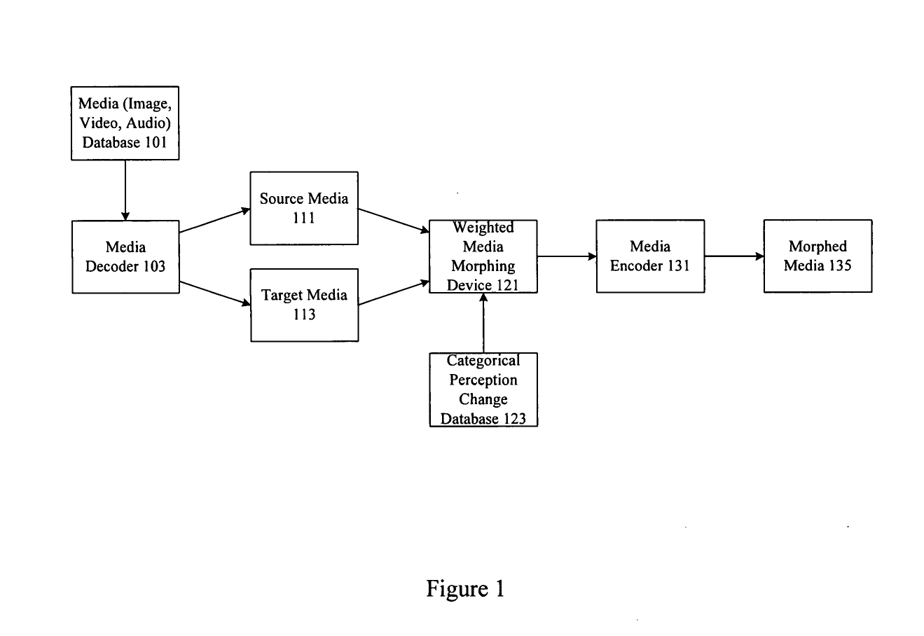

FIG. 1 illustrates one example of a system for performing neurologically informed morphing. A media database 101 includes images, video, and audio. The media database 101 provides media to a decoder 103. The media database 101 provides source media 111 and target media 113 through decoder 103. According to various embodiments, the source media 111 is a source image and the target media 113 is a target image. In particular embodiments, a user may want to obtain a morphed image that has an 80% source image contribution and a 20% target image contribution. In some examples, the morphed image has an 80% source image contribution and a 20% target image contribution for neurologically salient attributes like facial features while other portions of the image have a 90% source image contribution and a 10% target image contribution. Having different contributions for different portions of an image is referred to herein as weighted morphing.

A weighted morphing device 121 modifies the source image using the target image. Modifying the source image may involve warping the source images and target images by a certain percentage until features align and the warped images are then cross-dissolved. According to various embodiments, the weighted morphing device 121 may be implemented using hardware, firmware, or software, and uses information from a categorical perception change database 123 to determine what morphing factors to apply. For example, a categorical perception database 123 may indicate that the source image should have a 30% contribution for neurologically salient characteristics and a 20% contribution for other features.

According to various embodiments, the weight morphing device 121 applies different morphing factors to arrive at different contributions in the combined image. The combined image can be modified to improve the quality of the morph. The morph is then encoded at a media encoder 131 and provided as morphed media 135. The categorical perception change database 123 obtains information about categorical perception change using a variety of mechanisms, such as survey results, focus groups, and neurological and neurophysiological data. Information may include categorical perception change boundaries, neurologically salient feature information, weighted contribution levels, etc.

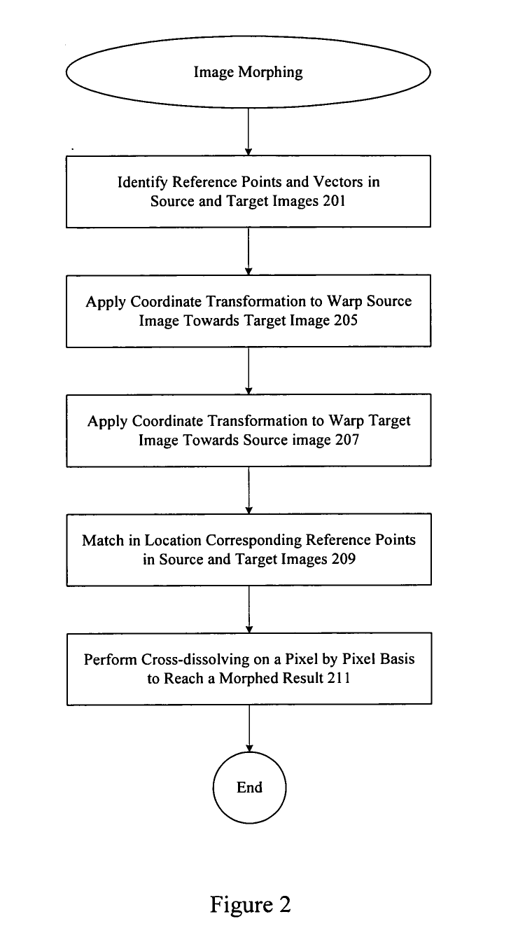

FIG. 2 illustrates one example of image morphing. It should be noted that mechanisms for image morphing can be applied to a series of images such as video. At 201, reference points and vectors in source and target images are identified. Reference points and vectors may correspond to particular facial features, edges, high contrast areas, etc. For example, multiple reference points and vectors may be used to identify the contours of a brow. Various landmark based and image based approaches can be used. Landmark based approaches use corresponding pairs of points and line segments in source and target images. Image based approaches identify features based on pixel intensities and variations. Eye, nose, and mouth detection algorithms can be applied to identify corresponding features. At 205, coordinate transformation is applied to warp the source image towards the target image. In one example, bilinear transformation maps quadrangles created by reference points in the source image to quadrangles created by corresponding reference points in the target image. At 207, coordinate transformation may also be applied to warp the target image to the source image.

At 209, the corresponding reference points in the source and target images are matched in location, i.e. the right eye in the source image is in the same position as the right eye in the target image. At 21 1, cross-dissolving is performed on a pixel by pixel basis to reach a morphed result. It should be noted that in some instances, a source image may be warped more significantly and the target image less significantly based on the desired contributions of the source and target images in the morphed image. The cross-dissolving component may also be varied depending on the desired contributions of the source and target images in the morphed image. Although a particular example of image morphing is described, it should be noted that mechanisms for image morphing can also be applied to animation, video clips, objects, etc.

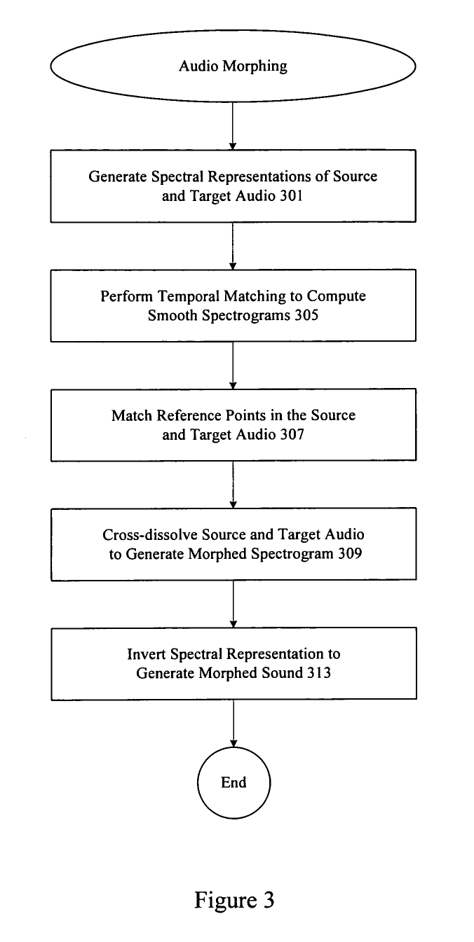

FIG. 3 illustrates one example of audio morphing. At 301, spectral representations of source and target audio are generated. In some instances, multiple spectral representations corresponding to different components of source and target audio are generated. In particular embodiments, mel-frequency cepstral coefficients are used to model audio. Cepstral coefficients allow separation of broad spectral characteristics of the source from the pitch and voicing information. At 305, temporal matching is performed to compute smooth spectrograms. At 307, reference points in the source and target audio are matched. In some embodiments, pitch matching, temporal matching, and spectral matching can all be applied. In particular embodiments, Dynamic Time Warping (DTW) is used to find the best temporal match between the two sounds. Over the course of the morph, features common to both source and destination audio remain fixed. According to various embodiments, paths are created between reference points in source audio and reference points in target audio. Source and target audio reference points are modified based on desired contributions of source and target audio in morphed audio.

At 309, source and target audio are cross-dissolved to generate a morphed spectrogram. At 313, the spectral representation is inverted to generate the morphed sound. It should again be noted that source audio may be modified more significantly than target audio or vice versa based on the desired contributions of the source and target audio to the morphed audio. A variety of audio morphing mechanisms can be used to invert the spectral representation back into morphed audio.

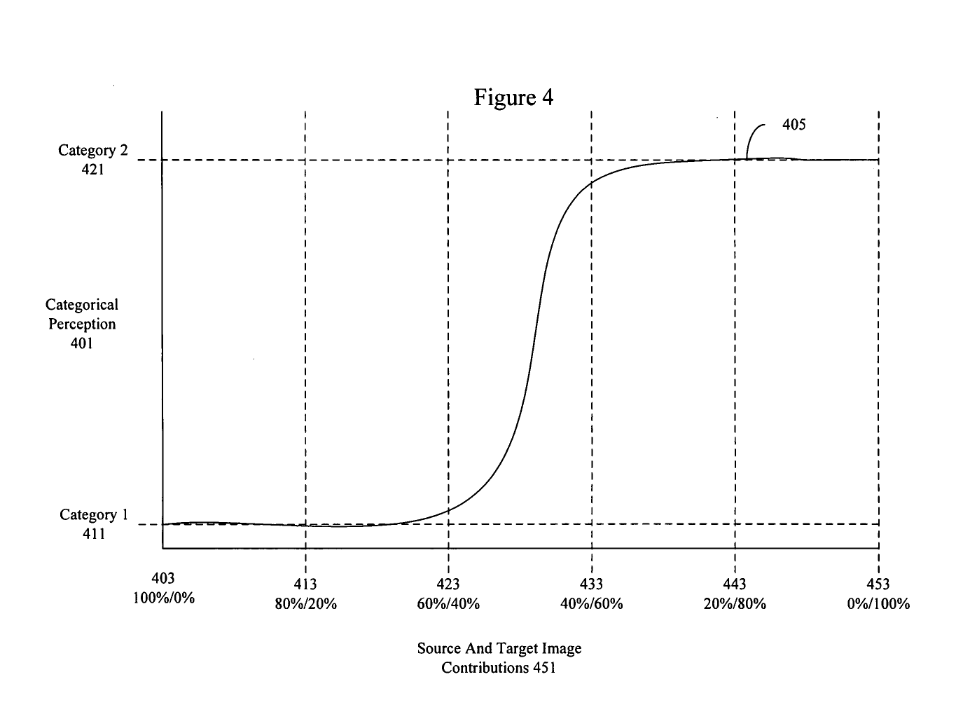

FIG. 4 illustrates one example of categorical perception change. An image is shown for illustrative purposes. However, it should be noted that the boundaries described apply to a variety of media. Categorical perception 401 is shown with respect to source and target image contributions 451. The categorical perception graph line 405 may represent an individual or a group of individuals. At 413, the source image contribution is 80% and a target image contribution is 20% in a morphed image. The subject classifies an image as falling in category 1, i.e. the image is an image of a cat. However, a subject may begin to consciously recognize that the image of the cat is a modified or morphed one. When the source image contribution is greater than 80%, for example, the subject may not recognize any modification to the image. The boundary 413 referred to herein as a modified media recognition boundary is significant, as it affects subject bias and persuasion. Consequently, it is often desirable to morph an image to a level that does not reach the modified media recognition boundary. It should be noted that in some morphs, there may be no modified media recognition boundaries 413 or 443 at all, as a subject may not recognize until a categorical perception shift that an image has been modified.

At 423, a source image contribution is 60% and the target image contribution is 40% and shows a categorical perception shift boundary. A subject begins to question whether an image falls within category 1 411 or category 2 421, i.e. whether the image is that of a cat or a dog. Between the categorical perception shift boundaries of 423 and 433, lateral frontal cortex activity increases significantly. According to various embodiments, the morphing contributions selected to affect bias and persuasion are selected to reside outside of the categorical perception shift region between the categorical perception shift boundaries of 423 and 433. The region between 403 and 423 is referred to herein as the pre-categorical perception shift region. The region between 433 and 453 is referred to herein as the post-categorical perception shift region. In some examples, the contributions selected reside near modified media recognition boundary 413. In still other embodiments, survey based, focus group, and/or neuro-response data is used to determine a source and target image contribution that affects customer bias while residing in a region outside of a categorical perception shift boundary.

Although specific contribution percentages are noted above for illustrative purposes, it should be noted that contribution percentages may change based on the type of media, the entities shown in the media, the morphing algorithms applied, and the weighting and neurologically salient features selected.

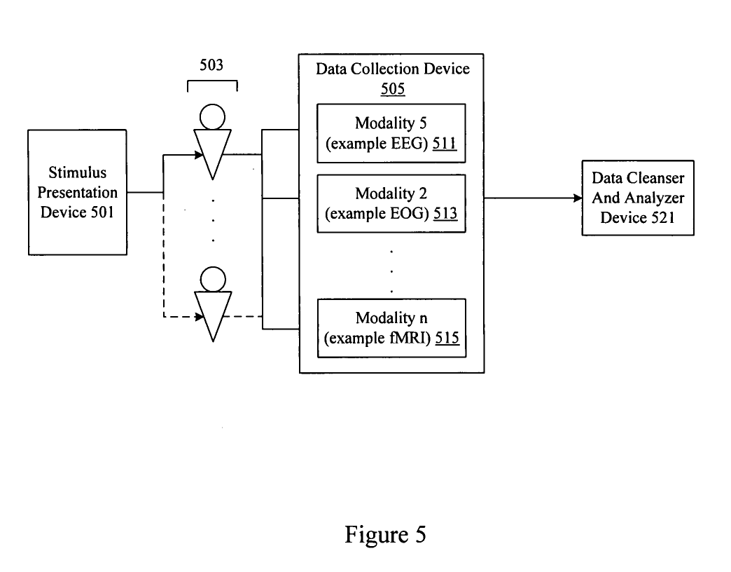

FIG. 5 illustrates one example of a system for analyzing categorical perception change and evaluating the effectiveness of weighted morphing. Neuro-response data can be collected and analyzed to determine categorical perception shift boundaries and modified media recognition boundaries on a per user or per group basis. Neuro-response data can also be used to determine contribution levels for source and target media in morphed media to influence bias and persuasion.

According to various embodiments, a system for implementing neurologically informed morphing includes a stimulus presentation device 501. In particular embodiments, the stimulus presentation device 501 is merely a display, monitor, screen, speaker, etc., that provides stimulus material to a user. Continuous and discrete modes are supported. According to various embodiments, the stimulus presentation device 501 also has protocol generation capability to allow intelligent customization of stimuli provided to multiple subjects in different markets.

According to various embodiments, stimulus presentation device 501 could include devices such as televisions, cable consoles, computers and monitors, projection systems, display devices, speakers, tactile surfaces, etc., for presenting the video and audio from different networks, local networks, cable channels, syndicated sources, websites, internet content aggregators, portals, service providers, etc.

According to various embodiments, the subjects 503 are connected to data collection devices 505. The data collection devices 505 may include a variety of neuro-response measurement mechanisms including neurological and neurophysiological measurements systems. According to various embodiments, neuro-response data includes central nervous system, autonomic nervous system, and effector data.

Some examples of central nervous system measurement mechanisms include Functional Magnetic Resonance Imaging (fMRI), Magnetoencephalography (MEG), optical imaging, and Electroencephalography (EEG). fMRI measures blood oxygenation in the brain that correlates with increased neural activity. However, current implementations of fMRI have poor temporal resolution of few seconds. MEG measures the magnetic fields produced by electrical activity in the brain via extremely sensitive devices such as superconducting quantum interference devices (SQUIDs). optical imaging measures deflection of light from a laser or infrared source to determine anatomic or chemical properties of a material. EEG measures electrical activity associated with post synaptic currents occurring in the milliseconds range. Subcranial EEG can measure electrical activity with the most accuracy, as the bone and dermal layers weaken transmission of a wide range of frequencies. Nonetheless, surface EEG provides a wealth of electrophysiological information if analyzed properly.

Autonomic nervous system measurement mechanisms include Galvanic Skin Response (GSR), Electrocardiograms (EKG), pupillary dilation, etc. Effector measurement mechanisms include Electrooculography (EOG), eye tracking, facial emotion encoding, reaction time etc.

According to various embodiments, the techniques and mechanisms of the present invention intelligently blend multiple modes and manifestations of precognitive neural signatures with cognitive neural signatures and post cognitive neurophysiological manifestations to more accurately allow assessment of alternate media. In some examples, autonomic nervous system measures are themselves used to validate central nervous system measures. Effector and behavior responses are blended and combined with other measures. According to various embodiments, central nervous system, autonomic nervous system, and effector system measurements are aggregated into a measurement that allows definitive evaluation stimulus material

In particular embodiments, the data collection devices 505 include EEG 511, EOG 513, and fMRI 515. In some instances, only a single data collection device is used. Data collection may proceed with or without human supervision.

The data collection device 505 collects neuro-response data from multiple sources. This includes a combination of devices such as central nervous system sources (EEG, MEG, fMRI, optical imaging), autonomic nervous system sources (EKG, pupillary dilation), and effector sources (EOG, eye tracking, facial emotion encoding, reaction time). In particular embodiments, data collected is digitally sampled and stored for later analysis. In particular embodiments, the data collected could be analyzed in real-time. According to particular embodiments, the digital sampling rates are adaptively chosen based on the neurophysiological and neurological data being measured.

In one particular embodiment, the alternate media system includes EEG 511 measurements made using scalp level electrodes, EOG 513 measurements made using shielded electrodes to track eye data, functional Magnetic Resonance Imaging (fMRI) 515 measurements made non-invasively to show haemodynamic response related to neural activity, using a differential measurement system, a facial muscular measurement through shielded electrodes placed at specific locations on the face, and a facial affect graphic and video analyzer adaptively derived for each individual.

In particular embodiments, the data collection devices are clock synchronized with a stimulus presentation device 501. In particular embodiments, the data collection devices 505 also include a condition evaluation subsystem that provides auto triggers, alerts and status monitoring and visualization components that continuously monitor the status of the subject, data being collected, and the data collection instruments. The condition evaluation subsystem may also present visual alerts and automatically trigger remedial actions. According to various embodiments, the data collection devices include mechanisms for not only monitoring subject neuro-response to stimulus materials, but also include mechanisms for identifying and monitoring the stimulus materials. For example, data collection devices 505 may be synchronized with a set-top box to monitor channel changes. In other examples, data collection devices 505 may be directionally synchronized to monitor when a subject is no longer paying attention to stimulus material. In still other examples, the data collection devices 505 may receive and store stimulus material generally being viewed by the subject, whether the stimulus is a program, a commercial, printed material, or a scene outside a window. The data collected allows analysis of neuro-response information and correlation of the information to actual stimulus material and not mere subject distractions.

According to various embodiments, the alternate media system also includes a data cleanser and analyzer device 521. In particular embodiments, the data cleanser and analyzer device 521 filters the collected data to remove noise, artifacts, and other irrelevant data using fixed and adaptive filtering, weighted averaging, advanced component extraction (like PCA, ICA), vector and component separation methods, etc. This device cleanses the data by removing both exogenous noise (where the source is outside the physiology of the subject, e.g. a phone ringing while a subject is viewing a video) and endogenous artifacts (where the source could be neurophysiological, e.g. muscle movements, eye blinks, etc.).

The artifact removal subsystem includes mechanisms to selectively isolate and review the response data and identify epochs with time domain and/or frequency domain attributes that correspond to artifacts such as line frequency, eye blinks, and muscle movements. The artifact removal subsystem then cleanses the artifacts by either omitting these epochs, or by replacing these epoch data with an estimate based on the other clean data (for example, an EEG nearest neighbor weighted averaging approach).

According to various embodiments, the data cleanser and analyzer device 521 is implemented using hardware, firmware, and/or software.

The data analyzer portion uses a variety of mechanisms to analyze underlying data in the system to determine resonance. According to various embodiments, the data analyzer customizes and extracts the independent neurological and neuro-physiological parameters for each individual in each modality, and blends the estimates within a modality as well as across modalities to elicit an enhanced response to the presented stimulus material. In particular embodiments, the data analyzer aggregates the response measures across subjects in a dataset.

According to various embodiments, neurological and neuro-physiological signatures are measured using time domain analyses and frequency domain analyses. Such analyses use parameters that are common across individuals as well as parameters that are unique to each individual. The analyses could also include statistical parameter extraction and fuzzy logic based attribute estimation from both the time and frequency components of the synthesized response.

In some examples, statistical parameters used in a blended effectiveness estimate include evaluations of skew, peaks, first and second moments, distribution, as well as fuzzy estimates of attention, emotional engagement and memory retention responses.

According to various embodiments, the data analyzer may include an intra-modality response synthesizer and a cross-modality response synthesizer. In particular embodiments, the intra-modality response synthesizer is configured to customize and extract the independent neurological and neurophysiological parameters for each individual in each modality and blend the estimates within a modality analytically to elicit an enhanced response to the presented stimuli. In particular embodiments, the intra-modality response synthesizer also aggregates data from different subjects in a dataset.

According to various embodiments, the cross-modality response synthesizer or fusion device blends different intra-modality responses, including raw signals and signals output. The combination of signals enhances the measures of effectiveness within a modality. The cross-modality response fusion device can also aggregate data from different subjects in a dataset.

According to various embodiments, the data analyzer also includes a composite enhanced effectiveness estimator (CEEE) that combines the enhanced responses and estimates from each modality to provide a blended estimate of the effectiveness. In particular embodiments, blended estimates are provided for each exposure of a subject to stimulus materials. The blended estimates are evaluated over time to assess resonance characteristics. According to various embodiments, numerical values are assigned to each blended estimate. The numerical values may correspond to the intensity of neuro-response measurements, the significance of peaks, the change between peaks, etc. Higher numerical values may correspond to higher significance in neuro-response intensity. Lower numerical values may correspond to lower significance or even insignificant neuro-response activity. In other examples, multiple values are assigned to each blended estimate. In still other examples, blended estimates of neuro-response significance are graphically represented to show changes after repeated exposure.

According to various embodiments, a data analyzer passes data to a resonance estimator that assesses and extracts resonance patterns. In particular embodiments, the resonance estimator determines entity positions in various stimulus segments and matches position information with eye tracking paths while correlating saccades with neural assessments of attention, memory retention, and emotional engagement. In particular embodiments, the resonance estimator stores data in the priming repository system. As with a variety of the components in the system, various repositories can be co-located with the rest of the system and the user, or could be implemented in remote locations.

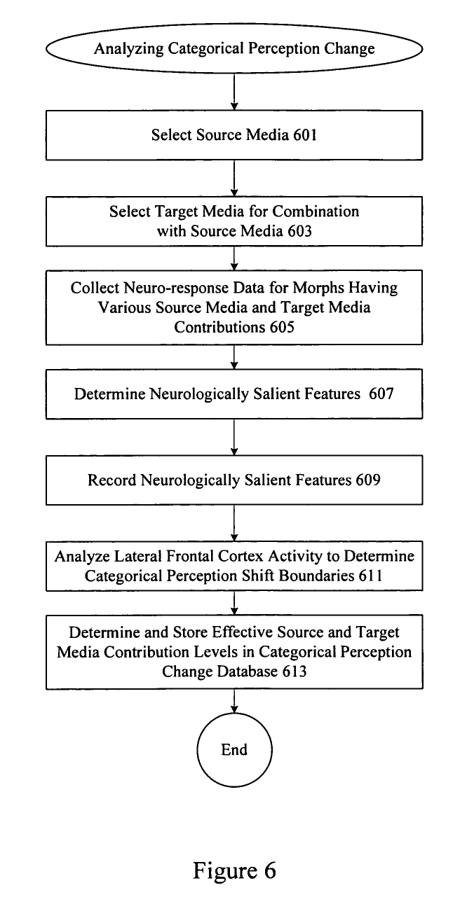

FIG. 6 illustrates an example of a technique for analyzing a categorical perception change. At 601, source media is selected. At 603, target media for combination with the source media is selected. According to various embodiments, source and target media may include images, commercials, films, video clips, audio, three-dimensional objects, structures, data, etc. In one example, a source video clip is selected and multiple target video clips are selected to determine which target video clip when morphed into the source video clip can most effectively influence consumer behavior. At 605, neuro-response data is collected for morphs having various source media and target media contributions. At 607, neurologically salient features are determined by applying more significant morphing to particular features or portions of media. For example, the eyes in an image may be 70% source image and 30% target image while the rest of the face may be 80% source image and 20% target image. According to various embodiments, an image of a face has an 80% source image contribution and a 20% target image contribution while an image of an inanimate object has a 70% source image contribution and a 30% target image contribution. At 609, neurologically salient features are recorded. At 611, lateral frontal cortex activity is analyzed to determine categorical perception shift boundaries. According to various embodiments, lateral frontal cortex activity significantly increases in the categorical perception shift region between categorical perception shift boundaries. At 613, effective source and target media contribution levels are determined and stored in a categorical perception change database.

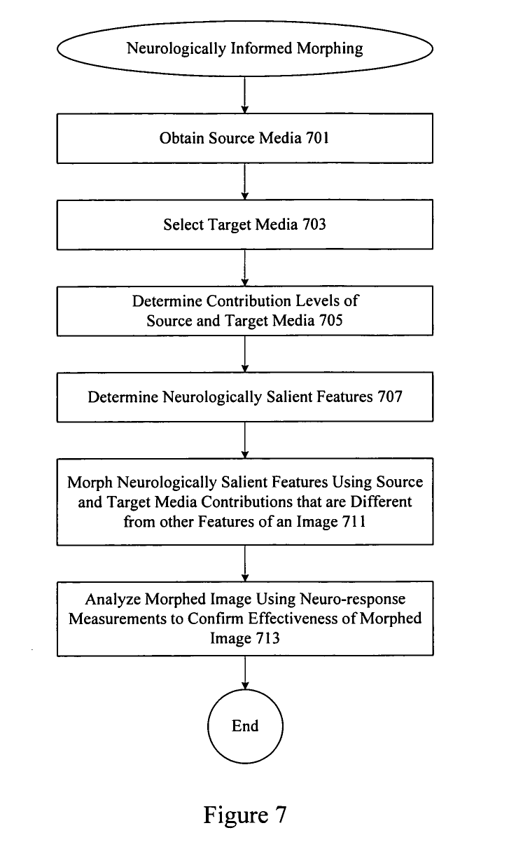

FIG. 7 illustrates one example of performing neurologically informed morphing. At 701, source media is obtained. At 703, target media is selected. According to various embodiments, the target media may be selected manually or automatically based on analysis of various candidate target media for a particular user or group. At 705, categorical perception shift boundaries and modified media recognition boundaries are used to determine contribution levels of source and target media. For example, a morphed image may be 75% source image and 25% target image. At 707, neurologically salient features may be determined. For example, neurologically salient features may include eyes and mouth. In other examples, neurologically salient features may include faces generally when bodies are morphed. According to various embodiments, neurologically salient features are morphed using source and target media contributions that are different from other features of an image at 711. For example, neurologically salient features are morphed to a 70% source image contribution and 30% target image contribution while other features are morphed to an 80% source image contribution and a 20% target image contribution.

At 713, the morphed image may be analyzed using neuro-response measurements to confirm the effectiveness of the morphed image. In some example, neuro-response measurements are used to determine neurological attention, emotional engagement, and retention component estimates.

According to various embodiments, the morphed media is provided to multiple subjects. In some examples, verbal and written responses are collected for use without neuro-response measurements. In other examples, verbal and written responses are correlated with neuro-response measurements. Subject neuro-response measurements are collected using a variety of modalities, such as EEG, ERP, EOG, fMRI, etc.

According to various embodiments, data analysis is performed. Data analysis may include intra-modality response synthesis and cross-modality response synthesis to enhance effectiveness measures. It should be noted that in some particular instances, one type of synthesis may be performed without performing other types of synthesis. For example, cross-modality response synthesis may be performed with or without intra-modality synthesis.

A variety of mechanisms can be used to perform data analysis. In particular embodiments, a stimulus attributes repository is accessed to obtain attributes and characteristics of the stimulus materials, along with purposes, intents, objectives, etc. In particular embodiments, EEG response data is synthesized to provide an enhanced assessment of effectiveness. According to various embodiments, EEG measures electrical activity resulting from thousands of simultaneous neural processes associated with different portions of the brain. EEG data can be classified in various bands. According to various embodiments, brainwave frequencies include delta, theta, alpha, beta, and gamma frequency ranges. Delta waves are classified as those less than 4 Hz and are prominent during deep sleep. Theta waves have frequencies between 3.5 to 7.5 Hz and are associated with memories, attention, emotions, and sensations. Theta waves are typically prominent during states of internal focus.

Alpha frequencies reside between 7.5 and 13 Hz and typically peak around 10 Hz. Alpha waves are prominent during states of relaxation. Beta waves have a frequency range between 14 and 30 Hz. Beta waves are prominent during states of motor control, long range synchronization between brain areas, analytical problem solving, judgment, and decision making. Gamma waves occur between 30 and 60 Hz and are involved in binding of different populations of neurons together into a network for the purpose of carrying out a certain cognitive or motor function, as well as in attention and memory. Because the skull and dermal layers attenuate waves in this frequency range, brain waves above 75-80 Hz are difficult to detect and are often not used for stimuli response assessment.

However, the techniques and mechanisms of the present invention recognize that analyzing high gamma band (kappa-band: Above 60 Hz) measurements, in addition to theta, alpha, beta, and low gamma band measurements, enhances neurological attention, emotional engagement and retention component estimates. In particular embodiments, EEG measurements including difficult to detect high gamma or kappa band measurements are obtained, enhanced, and evaluated. Subject and task specific signature sub-bands in the theta, alpha, beta, gamma and kappa bands are identified to provide enhanced response estimates. According to various embodiments, high gamma waves (kappa-band) above 80 Hz (typically detectable with sub-cranial EEG and/or magnetoencephalograophy) can be used in inverse model-based enhancement of the frequency responses to the stimuli.

Various embodiments of the present invention recognize that particular sub-bands within each frequency range have particular prominence during certain activities. A subset of the frequencies in a particular band is referred to herein as a sub-band. For example, a sub-band may include the 40-45 Hz range within the gamma band. In particular embodiments, multiple sub-bands within the different bands are selected while remaining frequencies are band pass filtered. In particular embodiments, multiple sub-band responses may be enhanced, while the remaining frequency responses may be attenuated.

An information theory based band-weighting model is used for adaptive extraction of selective dataset specific, subject specific, task specific bands to enhance the effectiveness measure. Adaptive extraction may be performed using fuzzy scaling. Stimuli can be presented and enhanced measurements determined multiple times to determine the variation profiles across multiple presentations. Determining various profiles provides an enhanced assessment of the primary responses as well as the longevity (wear-out) of the marketing and entertainment stimuli. The synchronous response of multiple individuals to stimuli presented in concert is measured to determine an enhanced across subject synchrony measure of effectiveness. According to various embodiments, the synchronous response may be determined for multiple subjects residing in separate locations or for multiple subjects residing in the same location.

Although a variety of synthesis mechanisms are described, it should be recognized that any number of mechanisms can be applied—in sequence or in parallel with or without interaction between the mechanisms.

Although intra-modality synthesis mechanisms provide enhanced significance data, additional cross-modality synthesis mechanisms can also be applied. A variety of mechanisms such as EEG, Eye Tracking, fMRI, EOG, and facial emotion encoding are connected to a cross-modality synthesis mechanism. Other mechanisms as well as variations and enhancements on existing mechanisms may also be included. According to various embodiments, data from a specific modality can be enhanced using data from one or more other modalities. In particular embodiments, EEG typically makes frequency measurements in different bands like alpha, beta and gamma to provide estimates of significance. However, the techniques of the present invention recognize that significance measures can be enhanced further using information from other modalities.

For example, facial emotion encoding measures can be used to enhance the valence of the EEG emotional engagement measure. EOG and eye tracking saccadic measures of object entities can be used to enhance the EEG estimates of significance including but not limited to attention, emotional engagement, and memory retention. According to various embodiments, a cross-modality synthesis mechanism performs time and phase shifting of data to allow data from different modalities to align. In some examples, it is recognized that an EEG response will often occur hundreds of milliseconds before a facial emotion measurement changes. Correlations can be drawn and time and phase shifts made on an individual as well as a group basis. In other examples, saccadic eye movements may be determined as occurring before and after particular EEG responses. According to various embodiments, fMRI measures are used to scale and enhance the EEG estimates of significance including attention, emotional engagement and memory retention measures.

Evidence of the occurrence or non-occurrence of specific time domain difference event-related potential components (like the DERP) in specific regions correlates with subject responsiveness to specific stimulus. According to various embodiments, ERP measures are enhanced using EEG time-frequency measures (ERPSP) in response to the presentation of the marketing and entertainment stimuli. Specific portions are extracted and isolated to identify ERP, DERP and ERPSP analyses to perform. In particular embodiments, an EEG frequency estimation of attention, emotion and memory retention (ERPSP) is used as a co-factor in enhancing the ERP, DERP and time-domain response analysis.

EOG measures saccades to determine the presence of attention to specific objects of stimulus. Eye tracking measures the subject's gaze path, location and dwell on specific objects of stimulus. According to various embodiments, EOG and eye tracking is enhanced by measuring the presence of lambda waves (a neurophysiological index of saccade effectiveness) in the ongoing EEG in the occipital and extra striate regions, triggered by the slope of saccade-onset to estimate the significance of the EOG and eye tracking measures. In particular embodiments, specific EEG signatures of activity such as slow potential shifts and measures of coherence in time-frequency responses at the Frontal Eye Field (FEF) regions that preceded saccade-onset are measured to enhance the effectiveness of the saccadic activity data.

According to various embodiments, facial emotion encoding uses templates generated by measuring facial muscle positions and movements of individuals expressing various emotions prior to the testing session. These individual specific facial emotion encoding templates are matched with the individual responses to identify subject emotional response. In particular embodiments, these facial emotion encoding measurements are enhanced by evaluating inter-hemispherical asymmetries in EEG responses in specific frequency bands and measuring frequency band interactions. The techniques of the present invention recognize that not only are particular frequency bands significant in EEG responses, but particular frequency bands used for communication between particular areas of the brain are significant. Consequently, these EEG responses enhance the EMG, graphic and video based facial emotion identification.

According to various embodiments, post-stimulus versus pre-stimulus differential measurements of ERP time domain components in multiple regions of the brain (DERP) are measured. The differential measures give a mechanism for eliciting responses attributable to the stimulus. For example the messaging response attributable to an advertisement or the brand response attributable to multiple brands is determined using pre-resonance and post-resonance estimates

According to various embodiments, various mechanisms such as the data collection mechanisms, the intra-modality synthesis mechanisms, cross-modality synthesis mechanisms, etc. are implemented on multiple devices. However, it is also possible that the various mechanisms be implemented in hardware, firmware, and/or software in a single system.

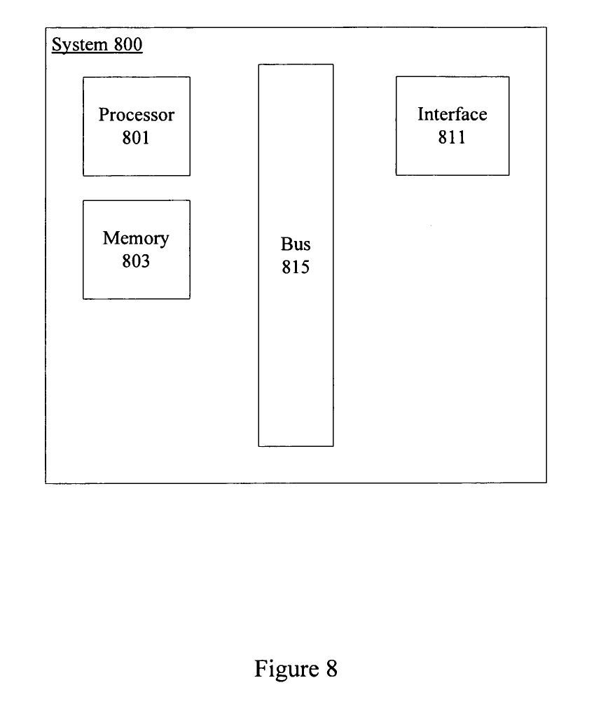

FIG. 8 provides one example of a system that can be used to implement one or more mechanisms. For example, the system shown in FIG. 8 may be used to implement an alternate media system.

According to particular example embodiments, a system 800 suitable for implementing particular embodiments of the present invention includes a processor 801, a memory 803, an interface 811, and a bus 815 (e.g., a PCI bus). When acting under the control of appropriate software or firmware, the processor 801 is responsible for such tasks such as pattern generation. Various specially configured devices can also be used in place of a processor 801 or in addition to processor 801. The complete implementation can also be done in custom hardware. The interface 811 is typically configured to send and receive data packets or data segments over a network. Particular examples of interfaces the device supports include host bus adapter (HBA) interfaces, Ethernet interfaces, frame relay interfaces, cable interfaces, DSL interfaces, token ring interfaces, and the like.

According to particular example embodiments, the system 800 uses memory 803 to store data, algorithms and program instructions. The program instructions may control the operation of an operating system and/or one or more applications, for example. The memory or memories may also be configured to store received data and process received data.

Because such information and program instructions may be employed to implement the systems/methods described herein, the present invention relates to tangible, machine readable media that include program instructions, state information, etc. for performing various operations described herein. Examples of machine-readable media include, but are not limited to, magnetic media such as hard disks, floppy disks, and magnetic tape; optical media such as CD-ROM disks and DVDs; magneto-optical media such as optical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
receiving source media;
receiving target media for morphing with the source media;
determining a first source media contribution level and a first target media contribution level for a morphing the source media and the target media, wherein the first source media contribution level and the first target media contribution level are selected after determining a pre-categorical perception shift region and analyzing the effectiveness of a plurality of source and target media contribution levels for influencing bias;
generating morphed media using the first source media contribution level and the first target media contribution level.

2. The method of claim 1, wherein target media is selected after analyzing the effectiveness of a plurality of target media for influencing bias.

3. The method of claim 1, wherein the pre-categorical perception shift region is determined by measuring activity associated with the lateral frontal cortex during subject exposure to a plurality of morphs having a plurality of different source and target media contribution levels.

4. The method of claim 1, wherein the effectiveness for influencing bias is determined using neuro-response data.

5. The method of claim 1, wherein the first source media and the first target media contribution levels reside outside of a categorical perception shift region.

6. The method of claim 1, wherein neurologically salient features associated with the source media are determined.

7. The method of claim 1, wherein neurologically salient features are morphed using the first source media contribution level and the first target media contribution level.

8. The method of claim 7, wherein non-neurologically salient features are morphed using a second source media contribution level and a second target media contribution level that are different from the first source media contribution level and the first target media contribution level.

9. The method of claim 7, wherein neurologically salient features comprise eye sand mouth.

10. The method of claim 1, wherein source media is an image, video, or audio.

11. A system, comprising:
an interface operable to receive source media and target media for morphing with the source media;
a processor operable to determine a first source media contribution level and a first target media contribution level for a morphing the source media and the target media, wherein the first source media contribution level and the first target media contribution level are selected after determining a pre-categorical perception shift region and analyzing the effectiveness of a plurality of source and target media contribution levels for influencing bias;
an output device operable to present the morphed media is generated using the first source media contribution level and the first target media contribution level.

12. The system of claim 11, wherein target media is selected after analyzing the effectiveness of a plurality of target media for influencing bias.

13. The system of claim 11, wherein the pre-categorical perception shift region is determined by measuring activity associated with the lateral frontal cortex during subject exposure to a plurality of morphs having a plurality of different source and target media contribution levels.

14. The system of claim 11, wherein the effectiveness for influencing bias is determined using neuro-response data.

15. The system of claim 11, wherein the first source media and the first target media contribution levels reside outside of a categorical perception shift region.

16. The system of claim 11, wherein neurologically salient features associated with the source media are determined.

17. The system of claim 11, wherein neurologically salient features are morphed using the first source media contribution level and the first target media contribution level.

18. The system of claim 17, wherein non-neurologically salient features are morphed using a second source media contribution level and a second target media contribution level that are different from the first source media contribution level and the first target media contribution level.

19. An apparatus, comprising:
means for receiving source media;
means for receiving target media for morphing with the source media;
means for determining a first source media contribution level and a first target media contribution level for a morphing the source media and the target media, wherein the first source media contribution level and the first target media contribution level are selected after determining a pre-categorical perception shift region and analyzing the effectiveness of a plurality of source and target media contribution levels for influencing bias;
means for generating morphed media using the first source media contribution level and the first target media contribution level.

20. The apparatus of claim 19, wherein target media is selected after analyzing the effectiveness of a plurality of target media for influencing bias.
